(19) United States
(12) Patent Application Publication
(10) Pub. No.: US 2022/0261092 A1
(43) Pub. Date: Aug. 18, 2022

(54) METHOD AND DEVICE FOR INPUTTING TEXT ON A KEYBOARD

(71) Applicant: Krishnamoorthy VENKATESA, Chennai (IN)

(72) Inventor: Krishnamoorthy VENKATESA, Chennai (IN)

(73) Assignee: Krishnamoorthy VENKATESA, Chennai (IN)

(21) Appl. No.: 17/613,914

(22) PCT Filed: May 15, 2020
(86) PCT No.: PCT/IN2020/050440

§ 371 Date: Nov. 23, 2021

(30) Foreign Application Priority Data
May 24, 2019 (IN) 201941020620

(51) Int. Cl. G06F 3/023; G06F 3/04886

(52) U.S. Cl. CPC G06F 3/0237; G06F 3/04886; G06F 3/0236

(57) ABSTRACT

A system and method for inputting text on a keyboard is disclosed. The method includes displaying a keyboard interface for receiving input gestures from a user, wherein the one or more input gestures indicate at least one of input text associated with a preselected language or an input trigger. Based on the input text and the input trigger, a hybrid-typing method, a swipe extension method, a gap-method, and/or a string creation method may be used for selecting words and/or strings from a database. The method predicts the words and/or strings based on the selected words/strings. The predicted words and/or strings are recited to the user via a speaker. The keyboard interface and method may enable visually challenged users to type efficiently without errors.

### CROSS-REFERENCES TO RELATED APPLICATIONS

This application claims priority to Indian Patent Application No. 201941020620 entitled METHOD AND DEVICE FOR INPUTTING TEXT ON A KEYBOARD filed on 24 May 2019.

### FIELD OF THE INVENTION

The disclosure generally relates to keyboard interfaces and, in particular, to methods and devices for inputting text on a keyboard by visually or physically challenged users.

### DESCRIPTION OF THE RELATED ART

Keyboard technology has evolved with advancements in electronic devices and software. Various software applications for communication including telephonic, text messaging, electronic messaging, instant messengers, etc., have enhanced user experiences with ergonomically designed keyboards. In spite of such developments, visually impaired users face many hurdles in typing on the existing keyboard technologies in smart phones with touch screens.

Currently, a visually challenged person inputs a text in touch screen phones using voice-over or talk-back feature. For instance, a visually challenged person may input text by touching a key on the keyboard and the device provides an audio feedback indicating which key is touched. If the desired key is touched, the user would take the hand and the desired letter or character is typed. If the touched key is not the desired one, the user is required to move the finger towards the desired key until the finger is on the desired key. In some operating systems, such as iOS, the desired letter has to be confirmed using a double tap. Thus, each letter is typed one by one in a tedious manner. Since the keys are small in a normal keyboard implementing any language, the user may often have to move the finger searching for the required key. Hence, it takes a lot of time for text input and creates frustration for such users.

Another popular text-input method known as “T9” is used in phone keyboards with 12 keys, each of which has multiple letters. The T9 keyboard requires only one tap per letter and, therefore, eliminates multiple taps for a letter. The software determines the matching words from a dictionary. Techniques using this type of single taps per letter are called dictionary methods. Some keyboards predict words even without a dictionary, which may create more choices for a sequence of taps. For example, in the standard 12 key English keyboard, the taps 2, 2, 8, generates “bat”, “cat”, and, “act”. Users with normal vision can see many options on the screen at the same time and choose the desired word quickly. However, visually challenged users cannot see the many options at once and can only hear the options one by one in a sequential way, which makes the process more time-consuming and inefficient.

Other keyboards predict words, by providing many options, after typing the first one or more letters. Some keyboards even predict the next word, by giving many options, when one word is completed. The method of word completion speeds up typing very much, for the normal user. However, keyboards implemented using these techniques do not solve the problem completely for the visually challenged, since the letters are input one at time by searching, and, only one word is read out at a time. Our main aim is to reduce the total time of inputting and selecting the required word.

For keyboards having one letter per key, swipe methods have been designed to input one word with one swipe. In this method, the user traverses a finger or stylus from the first letter to each of the other letters, one by one. Swipe methods give a word very quickly. However, the keys are small in a typical keyboard and swiping correctly is another problem for the visually challenged. When talk back is on, the last point of the swipe only is taken as input. Hence swipe is not directly available in current systems, when talk back is on. So visually challenged cannot use the normal swipe for whole word currently.

Various publications have attempted to address some of the challenges. U.S. Pat. No. 9,189,156 B2 (Howard Gutowitz) describes a keyboard comprising swipe-switches performing keyboard actions. Similarly, US20110210850 A1 (Phuong K Tran) describes touch-screen keyboard with combination keys and directional swipes. There is also a special keyboard available for the visually challenged, called Gestype, for iPhones, which works with 2 or 4 keys to eliminate incorrect taps. However, the user can input only one letter at a time. Therefore, these methods do not address the above-mentioned challenges and do not provide fast typing experience on a keyboard with high accuracy.

### SUMMARY OF THE INVENTION

The present subject matter relates to inputting text on a keyboard by visually or physically challenged users.

According to one embodiment of the present subject matter, a method of inputting text on an electronic device is disclosed. The method includes displaying, on a touch-sensitive display of the electronic device, a keyboard interface comprising a set of keys, wherein each key represents a plurality of characters for selection. One or more input gestures are received on the keyboard interface from a user, wherein the one or more input gestures indicate at least one of input text associated with a preselected language or an input trigger. The method includes identifying, by a processor of the electronic device, whether the one or more input gestures are indicative of input text or input trigger or both. In response to identifying the one or more input gesture indicative of input text: receiving, by the processor, a combination of predetermined swipe operations and predetermined tap operations to select a word from a preset dictionary database; or receiving, by the processor, a plurality of swipe operations performed continuously to select a word from the preset dictionary database.

In response to identifying the one or more input gestures indicative of input text and input trigger, wherein the input trigger is a gap request: inserting, by the processor, a gap between predetermined letters typed by the user as the input text, and selecting, by the processor, one or more words from the preset dictionary database based on the gap and the predetermined letters. The method includes predicting a word from the preset dictionary database based on the selected one or more words.

In response to identifying the one or more input gestures indicative of input text and input trigger, wherein the input trigger is a string request: selecting a collection from a plurality of collections stored in a preset string database based on the string request, wherein the plurality of collections comprises a letter strings collection, identifying a group of words associated with a letter string based on the input text, and predicting the letter string based on the identification. Finally, the method includes reciting, by a speaker of the electronic device, the predicted words or letter strings in real-time to the user for selection.

According to another embodiment of the present subject matter, a portable electronic device to assist a user for inputting text is disclosed. The device includes a processor, a touch-sensitive display, a memory unit, and a speaker. The touch-sensitive display is configured to: display a keyboard interface comprising a set of keys, wherein each key represents a plurality of characters for selection, and receive one or more input gestures on the keyboard interface from a user. The one or more input gestures may indicate at least one of input text associated with a preselected language or an input trigger. The memory unit may comprise a plurality of modules to be executed by the processor, the plurality of modules comprising a gesture module, a hybrid-typing module, a swipe extension module, a gap-method module, a string creation module, and a prediction module. The gesture module is configured to identify whether the one or more input gestures are indicative of input text or input trigger, or both. In response to identifying the one or more input gestures as indicative of input text, the processor executes one of a hybrid-typing module or a swipe extension module.

The hybrid-typing module is configured to enable the keyboard interface to receive a combination of predetermined swipe operations and predetermined tap operations to select a word from a preset dictionary database. The swipe extension module is configured to enable the keyboard interface to receive a plurality of swipe operations performed continuously to select a word from the preset dictionary database. Further, in response to identifying the one or more input gestures as indicative of input text and input trigger, and wherein the input trigger is a gap request, the processor executes: the gap-method module to insert a gap between predetermined letters typed by the user as the input text. It then selects one or more words from the preset dictionary database based on the gap and the predetermined letters.

Finally, in response to identifying the one or more input gestures as indicative of input text and input trigger, wherein the input trigger is a string request, the processor executes: a string creation module configured to: select a collection from a plurality of collections stored in a preset string database based on the string request. The plurality of collections may comprise a letter strings collection, and the string creation module identifies a group of words associated with a letter string based on the input text. The prediction module is configured to: predict a word from the preset dictionary database based on the one or more words selected by the hybrid-typing module, swipe extension module, or the gap-method module, or predict the letter string based on the identification by the string creation module. The speaker is configured to dynamically recite the predicted words or strings in real-time to the user for selection.

In some embodiments, the one or more input gestures comprise swipe operation, tap operation, or a three-dimensional motion input. In some embodiments, selecting words based on the combination of predetermined swipe operations and predetermined tap operations further comprises at least one of: selecting one or more letters of the word using a swipe operation from the preset dictionary database; or selecting one or more letters of the word using a tap operation from the preset dictionary database. In some embodiments, the plurality of swipe operations comprises one or more first predetermined sub-swipes and one or more second predetermined sub-swipes. Alternatively, the plurality of swipe of operations includes one or more second predetermined sub-swipes. In some embodiments, the first predetermined sub-swipes are indicative of navigation from one key to another key and the second predetermined sub-swipes are indicative of a subset of characters associated with a key. In some embodiments, inserting a gap comprises omitting one or more letters between the predetermined letters typed by the user as the input text. In some embodiments, the one or more input gestures indicate one of a text category, the text category comprising a number and symbol category, Braille symbol category, one or more language categories, symbol category, and a formatting category. In other embodiments, the method further comprises: selecting an emoji collection or a symbol collection from the plurality of collections stored in a preset string database based on the string request, identifying a group of words associated with emojis or symbols based on the input text, and predicting the emojis or symbols based on the identification.

The method further comprises in response to identifying the one or more input gestures indicative of input text and input trigger, wherein the input trigger is a string request and the input text is received using the plurality of swipe operations: selecting a collection from a plurality of collections stored in a preset string database based on the string request, wherein the plurality of collections comprises a letter strings collection, identifying a group of words associated with a letter string based on the input text; and predicting the letter string based on the identification.

In another embodiment, the keyboard interface is configured to receive one or more input gestures comprising a swipe operation, a tap operation, or a three-dimensional motion input. In some embodiments, the hybrid-typing module is configured to perform at least one of: selecting one or more letters of the word based on the swipe operation; or selecting one or more letters of the word based on the tap operation. In some embodiments, the plurality of swipe operations comprises one or more first predetermined sub-swipes and one or more second predetermined sub-swipes. Alternatively, the plurality of swipe of operations includes one or more second predetermined sub-swipes. In some embodiments, the first predetermined sub-swipes are indicative of navigation from one key to another key and the second predetermined sub-swipes are indicative of a subset of characters associated with a key. In some embodiments, the gap method module is further configured to omit one or more letters between the predetermined letters typed by the user as the input text, for inserting a gap. In some embodiments, the keyboard interface is configured to receive an input gesture indicative of a text category, wherein the text category comprises a number category, a symbol category, Braille symbol category, one or more language categories, or formatting category. In some embodiments, the processor executes the gap-method module and the swipe extension module in combination. In other embodiments, the processor executes the string creation module and the swipe extension module in combination. In some embodiments, the plurality of collections comprise letter string collection, emoji collection, or symbol collection, and wherein the letter string collection comprises phrases collection, idioms collection, proverbs collections, or user-defined phrases collection. In other embodiments, the device further comprises an emoji or symbol creation module configured to: select an emoji or symbol collection from a plurality of collections stored in a preset string database based on the string request, and identify a group of words associated with an emoji or symbol based on the input text.

According to another embodiment of the present subject matter, a computer program product having non-volatile memory therein, carrying computer executable instructions stored therein to assist a user for inputting text on an electronic device is disclosed. The instructions may include steps of a method of inputting text on an electronic device as disclosed in the foregoing.

This and other aspects are described herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates a device environment for inputting text using keyboard interface, according to one embodiment of the present subject matter.

FIG. 2 illustrates architecture of a device with keyboard interface, according to an embodiment of the present subject matter.

FIG. 3 illustrates a flow chart of a method of inputting text on the keyboard interface, according to one embodiment of the present subject matter.

FIG. 4 illustrates a keyboard interface, according to one embodiment of the present subject matter.

FIG. 5A illustrates one or more tap operations performed on a keyboard interface, according to one embodiment of the present subject matter.

FIG. 5B illustrates predetermined swipe operations originating from first key, according to another embodiment of the present subject matter.

FIG. 6 illustrates a keyboard interface with stroke operations for each key, according to an embodiment of the present subject matter.

FIG. 7 illustrates a keyboard interface with assignment of the alphabets in the English language to the different swipe operations, according to an embodiment of the present subject matter.

FIG. 8 illustrates a method of inputting a word, according to an embodiment of the present subject matter.

FIG. 9 illustrates keyboard interface with input gestures for typing a word using gap-method, according to an embodiment of the present subject matter.

FIG. 10 illustrates a keyboard interface wherein more than one option is available for a swipe, according to an embodiment of the present subject matter.

FIG. 11 illustrates a keyboard interface which shows the swipe for the word ‘beautiful’, according to an embodiment of the present subject matter.

FIG. 12 illustrates a keyboard interface with input gestures for combining gap-method and swipe extension method, according to an embodiment of the present subject matter.

FIG. 13 illustrates a keyboard interface with input gestures for inputting different actions, according to an embodiment of the present subject matter.

FIG. 14 illustrates a keyboard interface with input gestures for inputting text using dynamic abbreviation, according to an embodiment of the present subject matter.

FIG. 15 illustrates a keyboard interface with input gestures for combining dynamic abbreviation and swipe extension method, according to an embodiment of the present subject matter.

FIG. 16 illustrates a keyboard interface with input gestures for inputting emojis, according to an embodiment of the present subject matter.

FIG. 17 illustrates a keyboard interface with input gestures for creating phrases, according to an embodiment of the present subject matter.

FIG. 18 illustrates a keyboard interface with input gestures for creating phrases, according to another embodiment of the present subject matter.

FIG. 19 illustrates a keyboard interface with input gestures for typing numbers and symbols, according to an embodiment of the present subject matter.

FIG. 20 illustrates a keyboard interface with input gestures for typing numbers and symbols, according to an embodiment of the present subject matter.

FIG. 21 illustrates a keyboard interface with input gestures for typing numbers and symbols, according to another embodiment of the present subject matter.

Referring to the drawings, like numbers are intended to represent like parts throughout the illustrations.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on”. Referring to the drawings, like numbers indicate like parts throughout the views. Additionally, a reference to the singular includes a reference to the plural unless otherwise stated or inconsistent with the disclosure herein.

The various architectural components of the present invention may be distributed across various special purpose or general purpose computing devices, including various hardware components, such as personal computers, servers, laptops, hand-held devices, smart watches, wrist bands, keyboard projection devices, cell phones or the like, as discussed in greater detail below.

The terms “electronic device”, “portable electronic device”, or “computing device” encompass devices, such as servers, desktop computers, laptop computers, tablet computers, personal digital assistants (PDA), smartphones, mobile phones, smart devices, smart watches, wrist bands, wearable electronic devices, appliances, sensors, or the like. The electronic devices may include processing units, memory units, video or display interfaces, input/output interfaces, video or audio recording units, buses that connect the various units, network interfaces, peripheral interfaces, and the like. It may include any client device or a series thereof that may perform the desired computing operation and may include “rich” devices that are capable of performing a high degree of data processing, such as desktop personal computers (PCs) and “thin” clients that are less capable of processing data, such as cellular phones and pagers. It is understood that the distinction between a rich client and a thin client is a spectrum; there are many devices (hand-held or Tablet PCs) for example, that fall in the middle of the spectrum. Regardless of the device type or the processing capability of the client, most client devices may be operated by a user in either online or offline state.

The invention in its various embodiments proposes a keyboard interface ergonomically designed for visually challenged or physically challenged users. The present subject matter includes devices for implementing the keyboard interface and methods of inputting text using the keyboard interfaces.

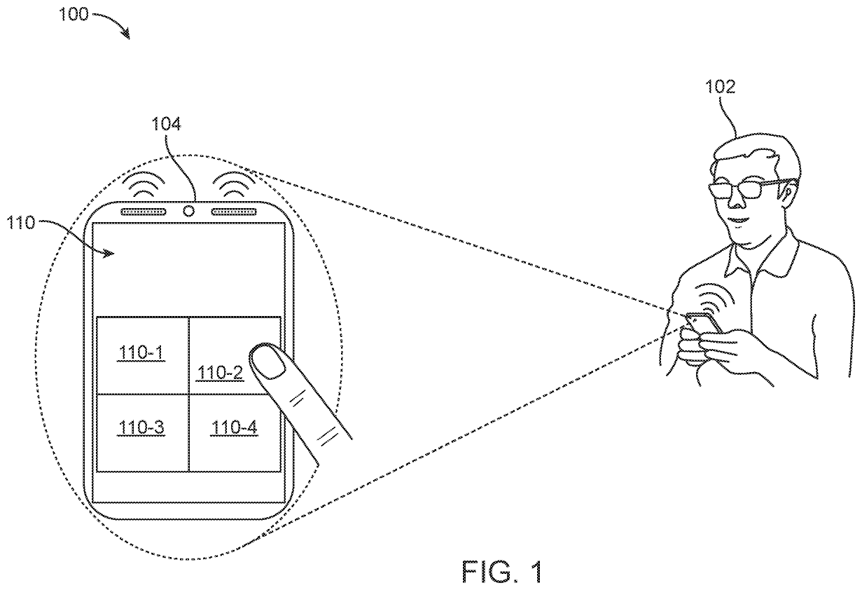

A device environment for inputting text using keyboard interface is illustrated in FIG. 1, according to one embodiment of the present subject matter. The environment 100 primarily includes a user 102, such as a visually challenged or physically challenged user, operating a user device 104. The user device 104 may primarily include a display unit 106 and a speaker unit 108, as shown. The display unit 106 may be configured to display a keyboard interface 110 having a set of keys 110-1, 110-2, 110-3, and 110-4. In various embodiments, the user device 104 may be an electronic device, such as a smartphone, a mobile phone, a smart device, a desktop computer, a laptop computer, a tablet computer, a personal digital assistant (PDA), smart watch, band, keyboard projection device, wearable device, appliance, sensor, server, or the like.

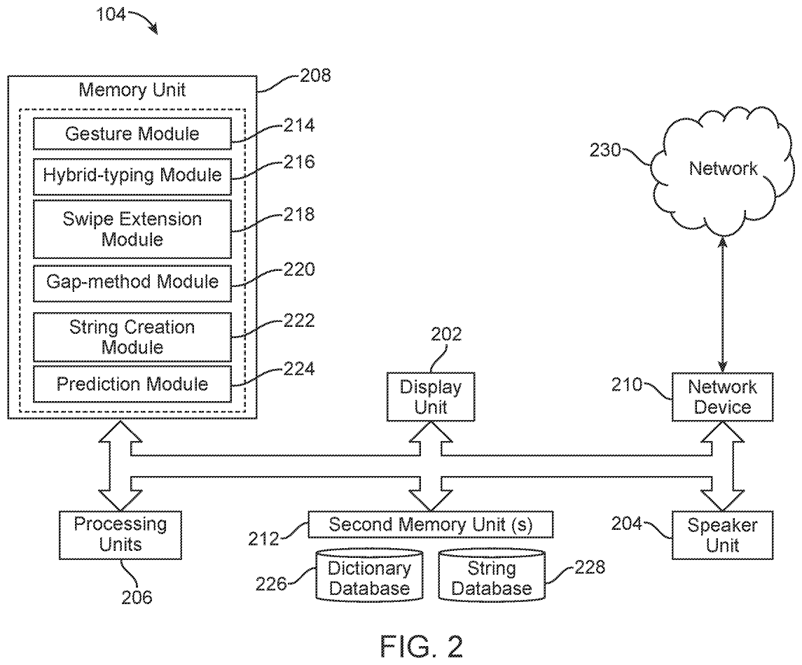

An architecture of the user device 104 is illustrated in FIG. 2, according to one embodiment of the present subject matter. The user device 104 may include a display unit 202, such as a touch-sensitive display, a speaker unit 204, processing units 206, memory unit 208, network interface 210, and a second memory unit 212. In some embodiments, the user device 104 may also include other subsystems, hard disks, and peripheral interfaces, such as a physical keyboard, mouse unit, a secondary display, a projector display, and the like. Some or all of the components may comprise or reside on separate computing devices or on the same computing device.

The display unit 202 may be configured to receive one or more input gestures from the user 102. In one embodiment, the display unit 202 may be one of a touch-sensitive display 106, as shown in FIG. 1. In another embodiment, the display unit may be configured to capture touchless gestures, such as three-dimensional actions, motions or gestures not involving touch inputs. For the sake of illustration and explanation, the display unit 202 is described herein with implementation via a touch-sensitive display 106. The touch sensitive display 106 may display the keyboard interface 110 comprising the set of keys 110-1, 110-2, 110-3, and 110-4.

Each key 110-1, 110-2, 110-3, and 110-4 represents a plurality of characters for selection. In various embodiments, each key represents at least half a dozen letters of a preselected language. The keyboard interface 110 may be configured to receive one or more input gestures on the keyboard interface from a user. In various embodiments, the input gestures may be a swipe operation or a tap operation. The input gestures may indicate at least one input text associated with the preselected language. For example, the input text may include alphabets of the preselected language, numbers or symbols associated with the language, etc. In some embodiments, the input gestures may indicate an input trigger. The input trigger may be a predetermined swipe or tap operation to trigger a specific method of inputting text on the keyboard interface 110. In various embodiments, the input gestures may indicate a text category, which may include a number and symbol category, Braille symbol category, and formatting category, and the like.

The memory unit 208 may include a plurality of modules to be executed by the processing units 206. The plurality of modules may include a gesture module 214, a hybrid-typing module 216, a swipe extension module 218, a gap-method module 220, a string creation module 222, and a prediction module 224. In various embodiments, the modules may be implemented as one or more software modules, hardware modules, firmware modules, or a combination of these. In various embodiments, the plurality of modules may be implemented in a distributed environment, for instance, one or more modules may be installed and executed in different networked devices.

The gesture module 214 may be configured to identify whether the input gestures are indicative of input text or input trigger or text category. If the input gesture is indicative of input text, the processor executes one of hybrid-typing module 216 or swipe extension module 218. The hybrid-typing module 216 may be configured to enable the keyboard interface 110 to receive a combination of predetermined swipe operations and predetermined tap operations to select a word from a second memory unit 212. Similarly, the swipe extension module 218 may be configured to enable the keyboard interface 110 to receive a plurality of swipe operations comprising one or more first predetermined sub-swipes and one or more second predetermined sub-swipes to select a word from the second memory unit 212. The first predetermined sub-swipes may be performed between the keys and the second predetermined sub-swipes may be performed within the key. In some embodiments, the plurality of swipe operations may include only second predetermined sub-swipes. The second memory unit 212 may be an in-memory database, which may include a dictionary database 226 and string database 228.

In various embodiments, the second memory unit 212 may be a physical storage media, such as RAM, ROM, EEPROM, CD-ROM or other storage such as optical disk storage, non-volatile storage, magnetic disk storage or other magnetic storage devices, or any other medium. In some embodiments, the memory or storage components may include a fixed media (e.g., RAM, ROM, a fixed hard drive, etc.) as well as removable media (e.g., a flash memory drive, a removable hard drive, an optical disk). Other examples may include dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), or any other type of media suitable for storing information. In other embodiments, the memory units may be used to carry or store desired program code means in the form of computer-executable instructions or data structures and, which can be accessed by a general purpose or special purpose computing device. The computer-executable instructions may include, for example, instructions and data which cause any general or special purpose computing device to perform a certain function or group of functions. In some embodiments, the dictionary database 226 and the string database 228 may be remote databases that may be accessed over a network 230. For example, the databases may rely on cloud technology and the content of such databases may be accessed and processed through open APIs or web browsers.

Referring back to the memory unit 208, the gap-method module 220 may be executed by the processor 206 in response to identifying that the input gestures are indicative of input text and input trigger, such as a gap request. The gap request may be a predetermined swipe or tap operation for initiating the gap-method module. The gap-method module 220 may be configured to insert a gap between predetermined letters that were typed by the user as the input text along with the gap request. The module may then select one or more words from the preset dictionary database 226 based on the gap and the predetermined letters typed.

The processor 206 may execute a string creation module 222 in response to identifying that the input gestures are indicative of input text and input trigger, wherein the input trigger is a string request. The string request may be another predetermined swipe or tap operation to enable the keyboard interface to receive abbreviations or acronyms as input text. The string creation module 222 may be configured to select a collection from a plurality of collections stored in the preset string database 228 based on the string request. The plurality of collections may include a letter strings collection. In various embodiments, the plurality of collections may include letter string collection, emoji collection, or symbol collection. The letter string collection may include phrases collection, idioms collection, proverbs collections, or user-defined phrases collection. The string creation module 222 identifies a group of words associated with a letter string based on the input text.

The prediction module 224 may be configured to predict word from the preset dictionary database based on the selected one or more words selected by the hybrid typing module, swipe extension module, or the gap-method module. The prediction module may also be configured to predict the letter string based on the identification by the string creation module. The speaker 204 may be configured to dynamically recite the predicted words or strings in real-time to the user for selection. The words or strings may be predicted and recited as the user finishes the input text. The user may select the recited word or strings for text entry by simply starting the input for the next word.

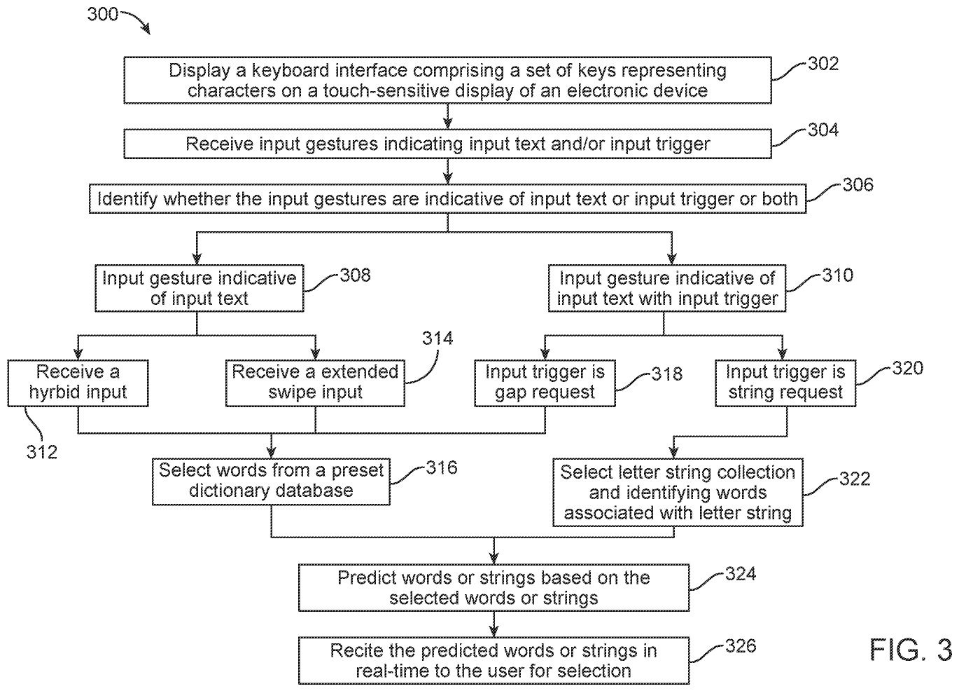

A flow chart of a method 300 of inputting text on the keyboard interface 110 is illustrated in FIG. 3, according to one embodiment of the present subject matter. The method includes displaying a keyboard interface 110 comprising the set of keys 110-1, 110-2, 110-3, 110-4 on touch-sensitive display 106 of the electronic device 104, at block 302. Each key represents a plurality of characters for selection. The method then includes receiving input gestures on the keyboard interface 110 from the user at block 304. The input gestures may indicate at least one of input text associated with preselected language or input trigger.

On receiving the input gestures, the method involves identifying whether the input gestures are indicative of input text or input trigger or both, at block 306. The identification may be performed by the processor of the electronic device. In various embodiments, the input gestures may be one or more of a swipe operation, a tap operation, or a touchless gesture operation. The touchless gesture operation in various embodiments may be detected by a camera or an image sensor. The touchless gesture may be interpreted as an operation on touch screen and may include providing gestures using body parts, such as hands, eyes, face, etc., without contacting the keyboard interface 110. In various embodiments, the touchless hand gesture operation may include three dimensional motion inputs, such as hand wave, pinch, bird's beak, etc.

In some embodiments, the input gestures may indicate at least one of input text associated with the preselected language at block 308. For example, the input text may include alphabets of the preselected language, numbers or symbols associated with the language, etc. In some embodiments, the input gestures may indicate input trigger at block 310. The input trigger may be a predetermined swipe or tap operation to trigger a specific method of inputting text on the keyboard interface 110.

In response to identifying that the one or more input gestures are indicative of input text, at block 308, the processor initiates a hybrid-typing method or a swipe extension method. The hybrid-typing method may include typing words using a combination of swipe operations or tap operations at block 312. For instance, the user may perform either a swipe operation to type one or more letters and perform tap operations to type one or more letters. Similarly, the swipe extension method may include receiving a plurality of swipe operations continuously, i.e., in one stroke, at block 314. Such a swipe operation may be considered to include one or more first predetermined sub-swipes and one or more second predetermined sub-swipes. Based on the received hybrid input and received extended swipe input, one or more words are selected from a preset dictionary database 226, at block 316. In some embodiments, the plurality of swipe operations may include only second predetermined sub-swipes.

Further, in response to identifying that the input gestures are indicative of input text and input trigger, the processor initiates a gap-method or string creation method. If the input trigger is a gap request, the keyboard interface is configured to insert a gap between predetermined letters typed by the user as the input text, at block 318. One or more words may be selected from the preset dictionary database based on the gap and the predetermined letters, at block 316. If the one or more input gestures are indicative of input text and input trigger, and the input trigger is a string request, as shown in block 320, the processor selects a letter string collection from a string database 228 and identifies words associated with the letter string based on the input text, at block 322. This method includes predicting strings of letters and/or symbols based on the identified one or more words at block 324. Finally, at block 326, the method includes reciting the predicted words or strings in real-time to the user for selection by the speaker 204.

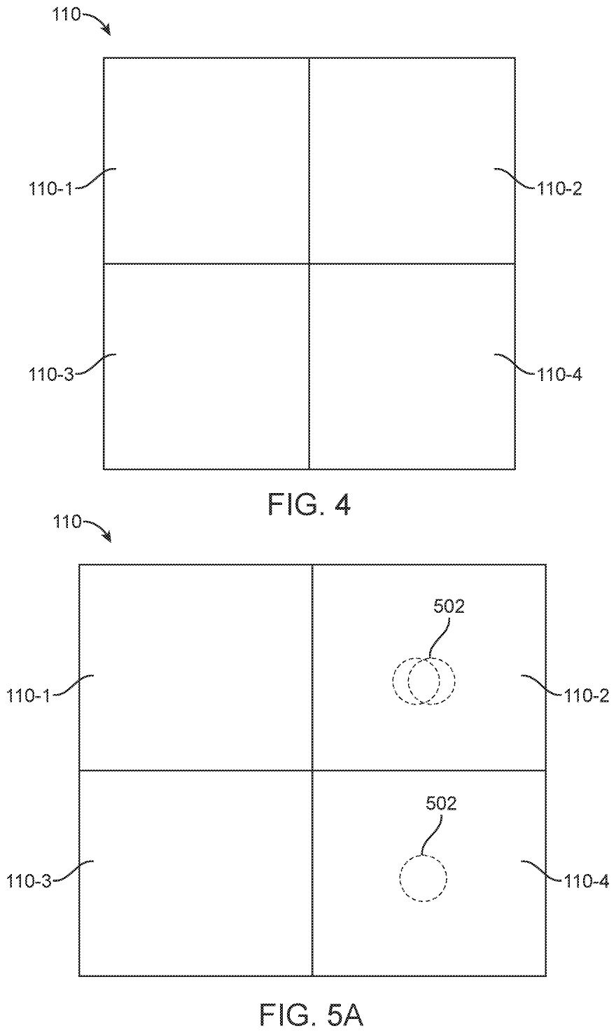

A keyboard interface 110 is illustrated in FIG. 4, according to one embodiment of the present subject matter. The keyboard interface 110 may include set of four keys 110-1, 110-2, 110-3, and 110-4 arranged as 2×2 grid. The keys are numbered 1 to 4—the top left key 110-1 is key 1, top right key 110-2 is key 2, bottom left key 110-3 is key 3, and bottom right key 110-4 is key 4. In some embodiments, the keyboard interface 110 may include variable number of keys. Each stroke begins at a corner of an imaginary square, moves along the edges of the imaginary square, of about half an inch length, and may end at another corner of that imaginary square. The imaginary squares enable the keyboard interface to distinguish different strokes or taps performed on the keys.

The methods of the invention may be implemented in a software application installed on a mobile computing device or any electronic device with a touch screen. The invention includes pre-installed application or software product for such devices, or computer program product that may be marketed on removable media or sold via a network.

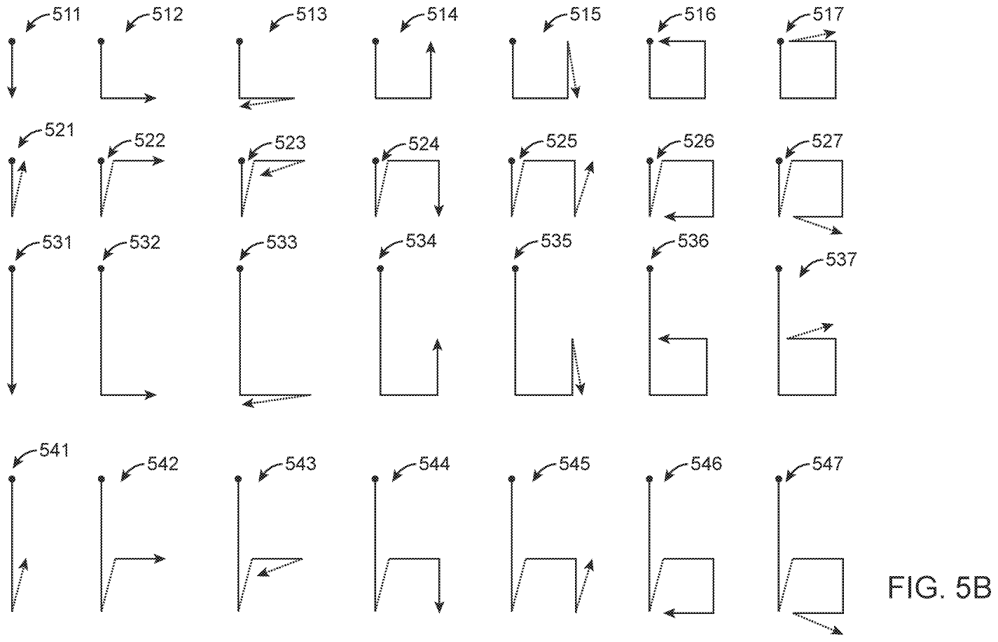

The keyboard interface 110 may be configured to receive one or more tap operations 502 as shown in FIG. 5A. In some embodiments, the tap operation 502 is performed to initiate an input trigger to trigger a specific method of inputting text or as an input gesture. In other embodiments, the tap operation is an input text associated with the preselected language.

Each swipe operation is performed to create a predetermined shape or “leaves”. The predetermined swipe operations originating from key 110-1 and moving down is illustrated in FIG. 5B, according to one embodiment of the present subject matter. Each swipe operation 511-547 is represented by a dot, one or more strokes, and an arrow. The dot represents the point of origin of the swipe operation and the arrow indicates the direction of the last stroke in the swipe operation. Further, all the strokes are represented either horizontally or vertically. Slanting strokes have been avoided as they are more probable to lead to ambiguity. The swipe operation 511 is referred to as 1, down. The swipe operation 515 is referred to as 1, down, right, up, back. The swipe operation 545 is referred to as 1, long down, back, right, down, back.

When the swipe operation 511 is performed in the first key 110-1, i.e., if the user begins in key 1 and moves down, a total of 28 different swipe operations may be created, which are arranged into four groups. The third and fourth groups represent swipe operations, whose first stroke is twice as long as that of the first stroke of the swipe operations in first and second groups. As an analogy, the 28 swipe operations may be considered as leaves of a tree, comprising 4 branches, wherein each branch has 7 leaves. Each row in FIG. 5B represents the 7 leaves of one branch. The four branches are numbered 511 to 517, 521 to 527, 531 to 537 and 541 to 547 as illustrated in this figure.

In this particular example, when the tree grows, first in the downward direction, from key 1, there is ample space to grow on the right side (towards keys 2 and 4). Therefore, all the continuations of the first stroke are on the right side. Each of the swipe operations given here may be shown for illustration as ideal shapes. Further, for the sake of visual clarity, a line overlapping the previous line is shown as a nearby dotted line (e.g. 513 or 521). In practical implementation, none of the swipe operations may be created in an ideal shape. The keyboard interface may be configured to fit a swipe to the nearest ideal swipe. In the event that no fit to an ideal swipe is found, that swipe may be ignored and informed to the user.

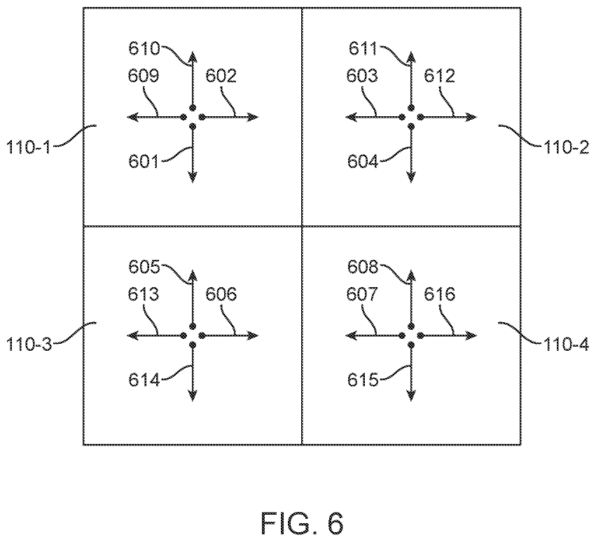

Further, the stroke operation 511 may be performed in four directions in any of the four keys as illustrated in FIG. 6, according to one example of the present subject matter. Therefore, there are 16 different ways in which such trees can grow, from the 4 keys. In trees growing in directions mentioned from 609 to 616, there is space only for the 14 leaves with short first stroke. The next 14 leaves are not possible, and hence not considered. So, in one key there are a total of 28+28+14+14=84 distinct swipes possible. With 4 keys, a total of 336 swipes may be available. Some of the said 336 swipes may be assigned a letter or a string of letters or a symbol or a string of symbols or a control function, or, a combination of plurality of letters and plurality of symbols and one control function. Some of the said 336 swipes may not have any assignment. Unassigned swipes may permit customization of the mapping between swipes and letters and allow for expanding the dictionary databases. In some embodiments of the method, the assignment design may be different for different languages.

The different text categories in some embodiments may be selected by providing a predetermined input gesture. The text categories may include, but are not limited to: letter mode, number and symbol mode, editing actions mode, Braille symbols mode, spell check dialog mode, and, find and replace dialog mode. Hence, the keyboard interface is configured to provide distinct swipes to get a large number of symbols and actions. Also, in some embodiments methods are provided to know the placement at any given direction of a key, in case one is not able to remember the placement there. This may be achieved in one embodiment by swiping front, back, front, in a key, in the direction left, up, right or down.

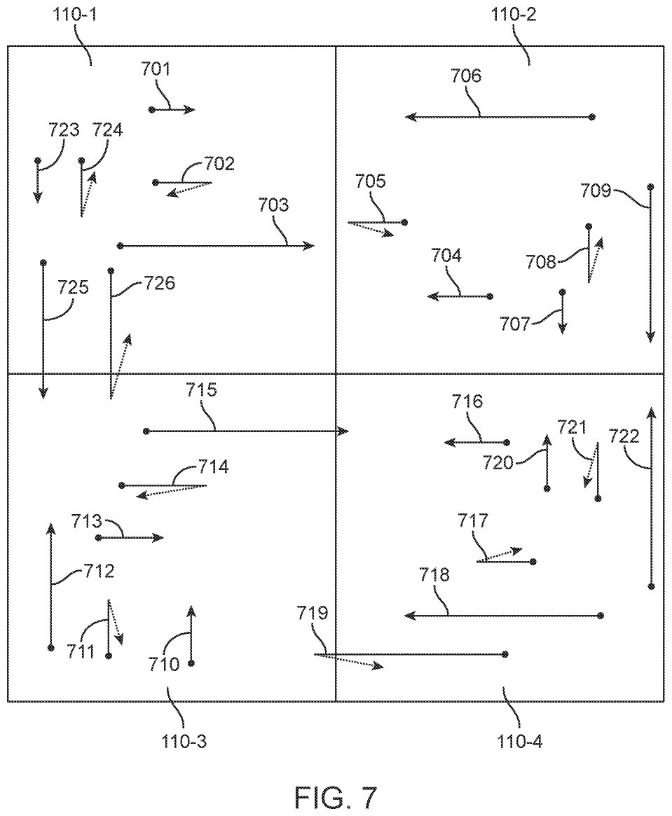

The assignment of the alphabets in the English language to the different swipe operations is illustrated in FIG. 7, according to one embodiment of the present subject matter. The swipe operations numbered from 701 to 726 may be assigned the small letters, a to z. Each key may represent around 6 alphabets. In some embodiments each key may represent at least about half a dozen letters in the disclosed keyboard interface, for any language. Here each small letter may be typed by one of the swipe operations 701-726.

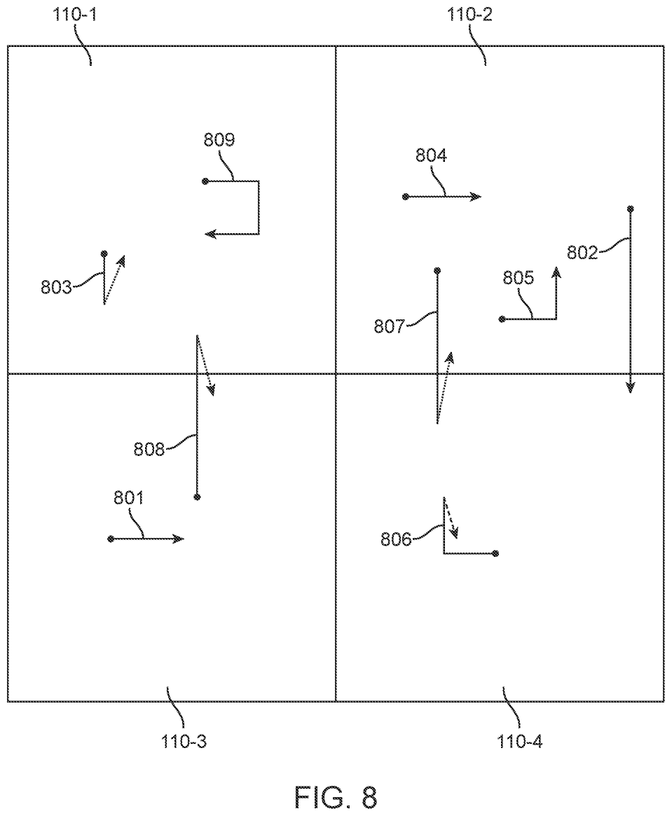

A method of typing a word not in the dictionary database 226 is illustrated using FIG. 8, according to one embodiment of the present subject matter. A word that is not in the dictionary database of the device may be input one letter at a time using swipe operations. For example, to add the word ‘mix’ 3 swipe operations for the letters, m, i, and, x, which are the swipes numbered 801, 802, 803, and the swipe numbered 804 are required. The swipe 804 is to indicate that the word is completed. In some embodiments, if an auto-space option is kept ON, then a space will be sent out after the word automatically. In some embodiments, the typed word may be modified using features, such as subscript, superscript, capitalizing first letter, uppercase etc. These are achieved by using different swipe operations at the end of the word. For example, the swipes 801, 802, 803, and, 805, would render the current word ‘mix’ as a superscript.

Some letters may be used more frequently than other letters, for example, the letter ‘e’ may be chosen since it is the most commonly used letter in English. For example, a letter may come with the letter ‘e’ appended at the end of the typed letter. The swipe operation 806, shows the swipe for ‘pe’ in one embodiment. The swipe operation 807 gives the letters ‘ing’ and an end of word trigger in one embodiment. The swipe 808 gives the word ‘light’ in one embodiment. The swipe 809 gives the words ‘as soon as possible’ in one embodiment, an entire phrase. So one swipe may even produce a long string and a trigger.

In some embodiments, the hybrid-typing method may be used for faster text entry. The hybrid-typing method involves swipe operations for some letters and tap operations for other letters. For instance, if the first and last few letters are in swipes, and the others in taps, then the method allows quickly narrowing down to an intended word. In one example, the swipe operation for “c” followed by the taps on the keys 110-1, 110-4, 110-1, 110-2, then the swipe 804, generates only “catch”. This may be faster than the word got by a typing method involving only swipes, or, only taps. The basic principle used in hybrid-typing is that, when some letters are fixed in some positions, the number of words predicted is reduced. In some embodiments the combination of swipes and taps may be available within a single word.

In various embodiments, the method allows many small and medium sized words to be typed with ease using the stroke method or the above mentioned hybrid method. In some embodiments, for long words, the gap method may be used to reduce the time to type. The keyboard interface is used to insert a gap by omitting one or more letters in the middle of a word. The gap request may be indicated by a predetermined swipe operation. In one embodiment, the swipe operation, 4, up, left, down, right, which is a small square, represents a gap. This gap represents an invisible character, which is substituted by any number of real characters.

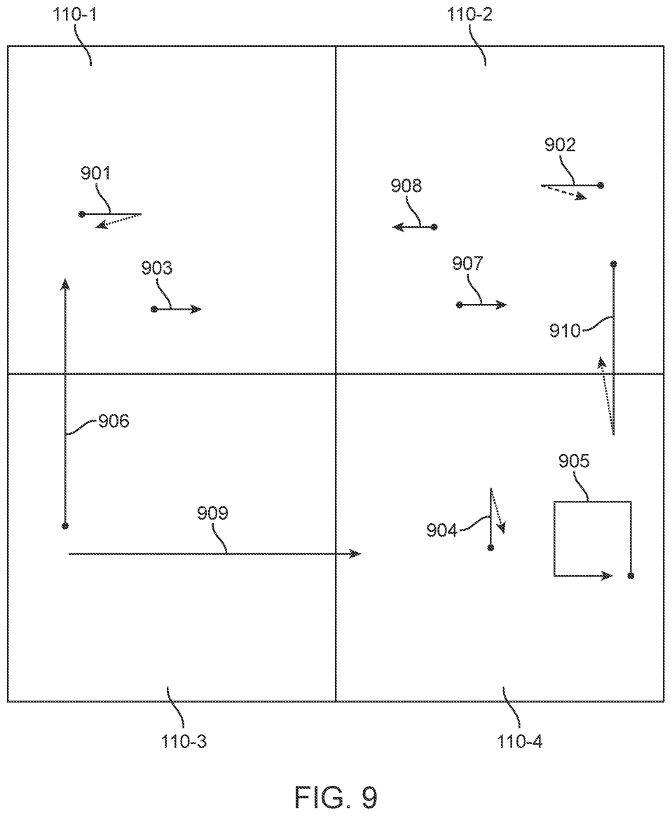

A keyboard interface with input gestures for typing a word using gap-method is illustrated in FIG. 9, according to one example of the present subject matter. The gap method may be used to reduce the time to type longer words. For example, in order to type the word “beautiful”, the user may perform the swipe operations 901 to 907 for typing the letters “b”, “e’, “a”, “u”, for inputting a gap, then to input letter “1” and finally the end of word swipe 907. The keyboard interface inserts a gap by omitting one or more letters in the middle of the words in the preset database of words. The gap request may be indicated by a predetermined swipe operation. This method takes less time than giving all the letters. Further, swipes for b, e, a, u, swipe for gap, and, tap on 3, gives beautiful, beautician, and, beautification, in this sample manifestation, since 1, m, and n, are all in key 3. This shows the advantage of using a swipe instead of a tap. Additionally, when the user is not sure of a letter in the middle of a long word, the user can avoid typing that letter by using a gap, and still get the word with correct spelling. This is an added advantage.

In one example, given using FIG. 9, “ing” may be used for forming an end of a word. The keyboard interface may use a swipe operation for adding “ing” to complete a word, i.e., there may be no need to convey the device that a word is complete. For example, the swipes 908, 909, and 910 give “doing”. Here the swipe 910 after providing the string “ing”, triggers automatically the action for finding matching words for the hybrid input.

Further, in various embodiments the swipe extension method as described earlier may include a plurality of swipe operations involving one or more first predetermined sub-swipes and one or more second predetermined sub-swipes to select a word from the preset dictionary database. Alternatively, the plurality of swipe operations may include only second predetermined sub-swipes only.

When a swiping operation is begun, there will not be any incoming stroke at the starting key. Hence there will not be a first predetermined sub-swipe of type 1. For the starting key, a second predetermined sub-swipe is compulsory. In some embodiments, use of second predetermined sub-swipe is optional for the middle keys, provided there is exactly one letter from that key, when entering that key, i.e., the previous and the next letters are from other keys.

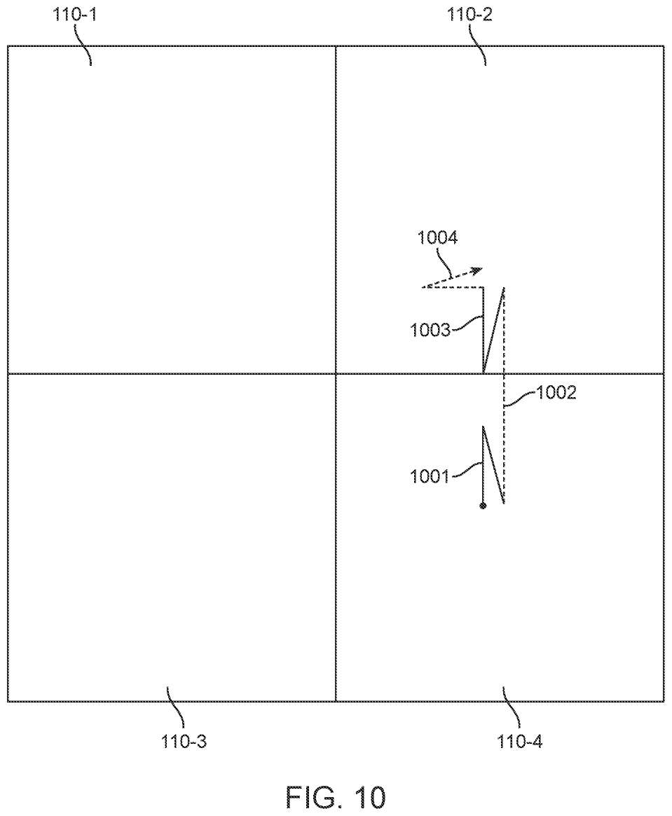

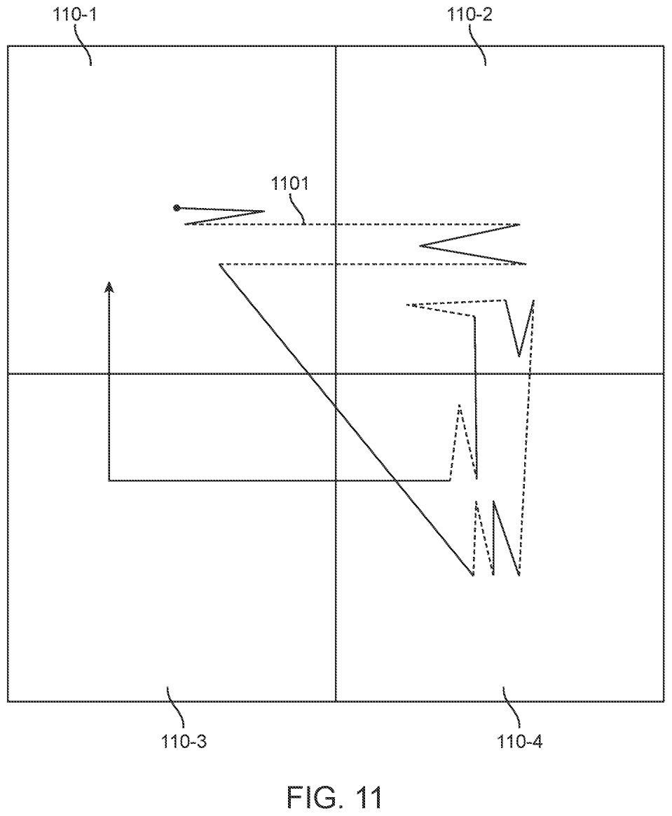

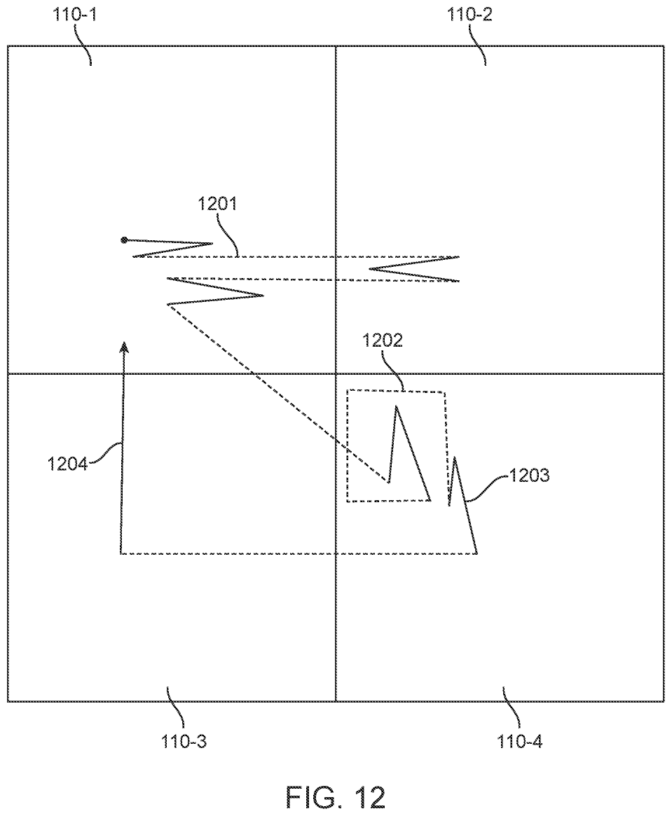

An example where more than one option is available for a swipe is shown in FIG. 10, according to one embodiment of the present subject matter. Sub-swipe 1001 indicates that the letter selected for entry is either ‘t’ or ‘u’. Sub-swipe 1002 is a first predetermined swipe indicating that the sub-swipe is moving from 110-4 to 110-2. The first predetermined sub-swipes may be indicative of navigation from one key to another key and the second predetermined sub-swipes may be indicative of a subset of characters associated with a key. If the second predetermined sub-swipe is absent in a key, then all the letters in that key are considered. In some embodiments, the first predetermined sub-swipe is of length that is about two times the length of the normal imaginary square. Sub-swipe 1003 may indicate that the letter selected is either ‘g’, ‘h’, or T. Sub-swipe 1004 may indicate that the last letter is ‘e’. Two options formed from these letters are selected from the dictionary: “the” and “tie”. Swipe 1101 of FIG. 11 shows the swipe for the word ‘beautiful’. Note that for the middle letter ‘a’, the second predetermined sub-swipe has been omitted. But for the middle letter second u, the predetermined second sub-swipe is not omitted. For the sake of easy understanding, alternate sub swipes are shown by normal and dashed lines.

In some embodiments, the second predetermined sub-swipes may be of 3 types. The first type is for the first key of the swipe. The second type is for a key in the middle. The third type is for the last key. Use of type 2 sub swipes in a key reduces the options considerably and allows quick selection of the intended word.

In one embodiment, a gap-method may be used in combination with the extended swipe method. A special second predetermined sub-swipe may be provided as input to represent such a gap. The special sub-swipe is a square of usual size, starting and ending in the same key. The sub-swipe may not interfere with any other sub-swipe. Hence, its availability in all the keys saves the time of navigating to a particular key. The sub-swipe 1202 represents a gap. The full swipe 1201 shows the swipe where the three letters ‘t’, T and ‘f’ are omitted. The second sub-swipe 1203 representing the letter u, coming after the gap, may also be omitted. The swipe operation ends with the within-the-key second type sub-swipe 1204.

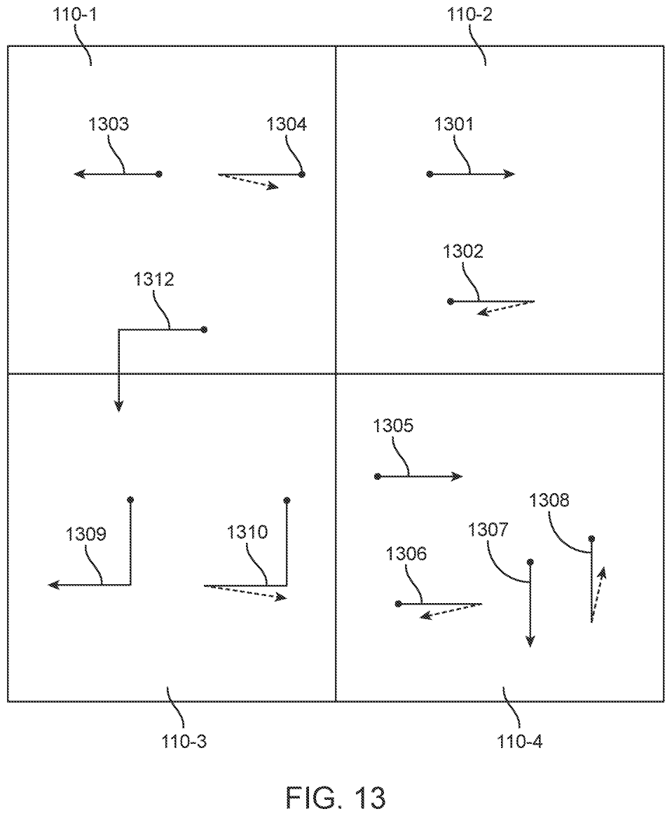

A keyboard interface with input gestures for inputting different action triggers is illustrated in FIG. 13, according to one embodiment of the present subject matter. The input trigger (string request) represented by the swipe 1312 gives a menu of different actions. Navigating through this menu, a list of words or strings and their abbreviations may be added and kept in the secondary memory or the string database of the device. In one embodiment, the keyboard interface may provide an option to switch ON or OFF for use of abbreviations, on receiving the input trigger (string request) 1312. When abbreviation use is ON, the keyboard interface is configured to receive a word as input, say by the swipe (2, right) 1301, then the processor checks the list of abbreviations in the string database having abbreviations and expansions, and if any match is found, instead of the string input, the corresponding expansion is sent out. If the output is not the required output, performing swipe (2, right) 1301 again will give next option. In this way every available option may be checked by repeated application of the swipe 1301.

Further, the swipe 1302 may give the option shown just before the current option. Swipe 1303 may UNDO the last action done in the text box. Swipe 1304 may REDO the last undo action in the text box. Swipe 1305 may send a space to the text box. Swipe 1306 may send a backspace to the text box. Swipe 1307 may send a full stop to the text box. Swipe 1308 may send a comma to the text box. Swipe 1309 may move the cursor left. Swipe 1310 may send the command ENTER to the text box.

In some embodiments, the new dynamic abbreviation method may be used to create many thousands of strings quickly, without remembering the abbreviations. For example, the strings database may store a collection of strings. The collection may be well known proverbs, idioms or phrases, or the collection may be specific user defined phrases, pertaining to a particular domain. The user may be required to remember the phrases in this collection. While typing, the collection to be used may be specified first. Each time a user may create a different abbreviation, for the same phrase. The processor determines the matching phrases, from the specified collection of phrases and returns the result to the text box and also via the speaker.

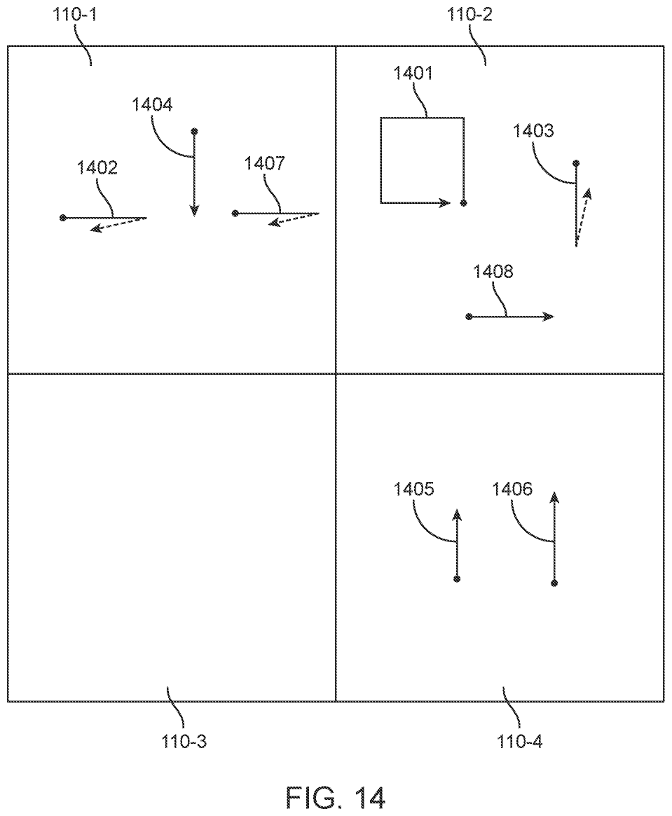

In some embodiments, a dynamic abbreviation may be created as follows: Temporarily fix the variable n to be a number from 1 to 4. Take n number of starting letters, from one or more words of the phrase, from specified database of phrases. The chosen words must be in the order in which they appear in the phrase, which may be indicated by some initial strokes, or, taps, or, initial parts of the swipe. The input trigger given by the swipe operation 1401 (2, up, down, up, down) in FIG. 14, indicates the following strokes or taps should use the collection of phrases. Also, one letter is taken from one word. When end of the dynamic abbreviations is detected, by the swipe 1408, the processor checks all the phrases in the specified collection, and picks up the phrases which match the given abbreviation. The matching phrases will be output one by one, with phrases with smaller number of words first.

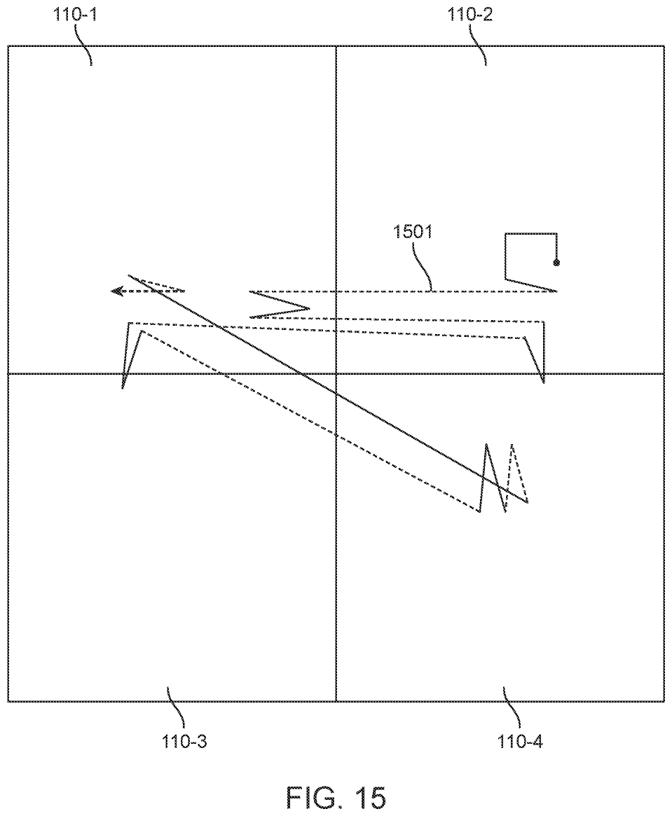

The database may be a collection of proverbs, idioms and phrases. The letters—b h w t t b—would fetch the proverb “a bird in the hand is worth two in the bush”, as the only option, from this collection. The swipes 1401 to 1408, in that order, may be used to achieve this. Note that getting a proverb in this way may be very fast. In some embodiments, the dynamic abbreviation may be used in combination with extended swipe as illustrated in FIG. 15. The said collection specification and the required letters may also be obtained by using one swipe 1501, which fetches the entire sentence with just one swipe.

In alternative embodiments, dynamic abbreviation may also be used to input some subset of symbols in the Unicode chart. A subset of related symbols may be defined as a collection. For example, emojis may be such a collection. Higher mathematical symbols, and, musical symbols, may form some other collections. The dynamic abbreviation is created using the name of a symbol as the expanded text, but the output is the symbol, and not the name of the symbol. This enables inputting any symbol, from any of the previously defined collections.

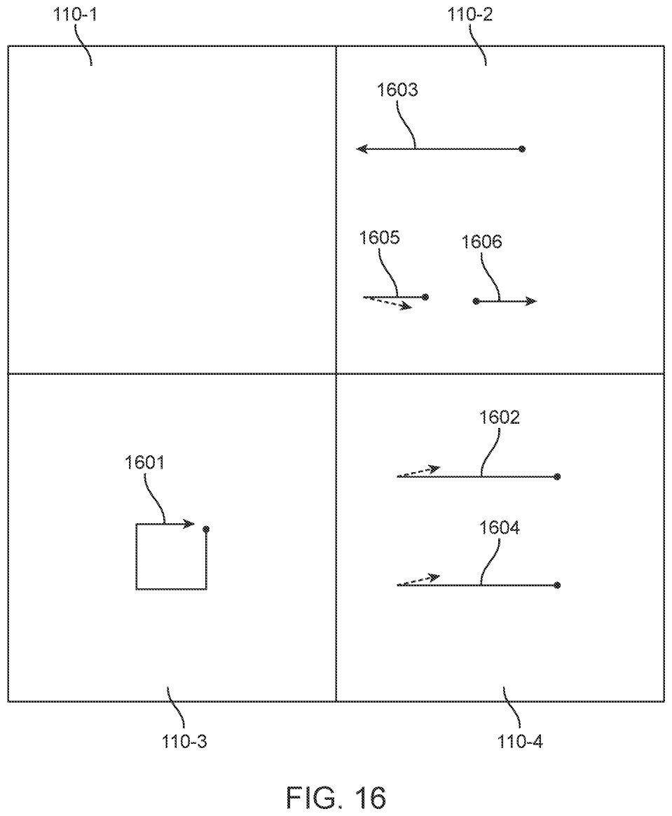

A keyboard interface with input gestures for inputting emojis is illustrated in FIG. 16, according to one embodiment of the present subject matter. The swipe operations 1601 to 1606, in that order, give the required emoji. The input of letters—s f s e—fetches the emoji with ‘smiling face with smiling eyes’ first, from the emoji list. The next and final option is the emoji with ‘smiling face with open mouth and smiling eyes’. In one embodiment, the name with less number of words is given first. Key 110-3 specifies the Emojis collection. In other embodiments, the symbols using their names may also be fetched using a single extended swipe.

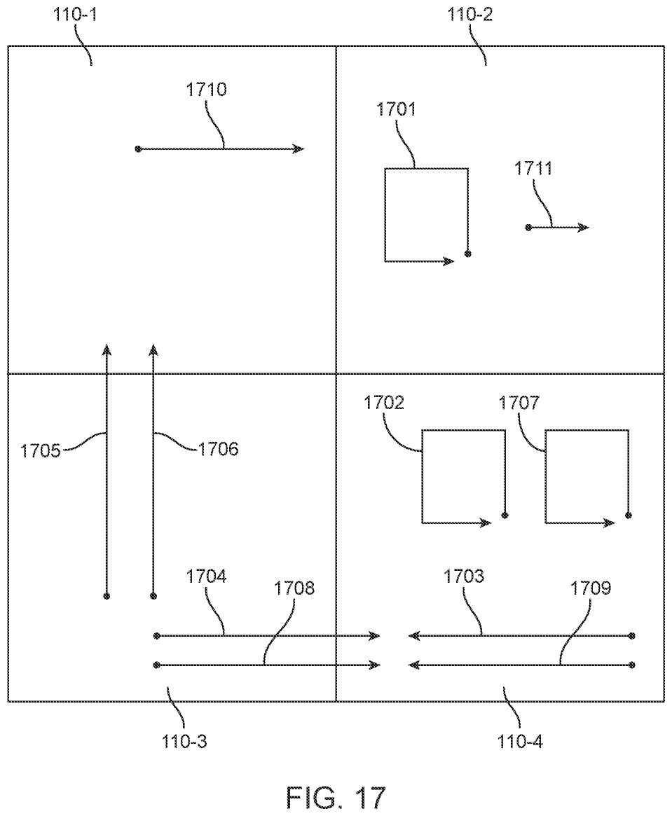

A keyboard interface with input gestures for creating phrases is illustrated in FIG. 17, according to one embodiment of the present subject matter. There may be instances when in a phrase, one or more words may have a large number of choices of words. A very simple example where any of the words: in, his, her, or your, can fit in the place of plus sign is, “+ tail between + legs”. Instead of having one entry per variation, it may be specified that in the specified places, the user may provide the full word. Another example is the phrase “+ out the red carpet”. Here any of the words, roll, rolls, rolled, rolling, can fit in. The swipes 1701 to 1711, in that order, give the output “roll out the red carpet”. Here the letters used are r, o, l, l, o, r, c. The first four letters form a full word. They are given between the swipes 1702 and 1707. These two swipes represent the presence of a full word, when used with dynamic abbreviation. The above method of giving full words in between would be useful when students use some sentences from their text books, and the students are required to give the technical terms in full while writing.

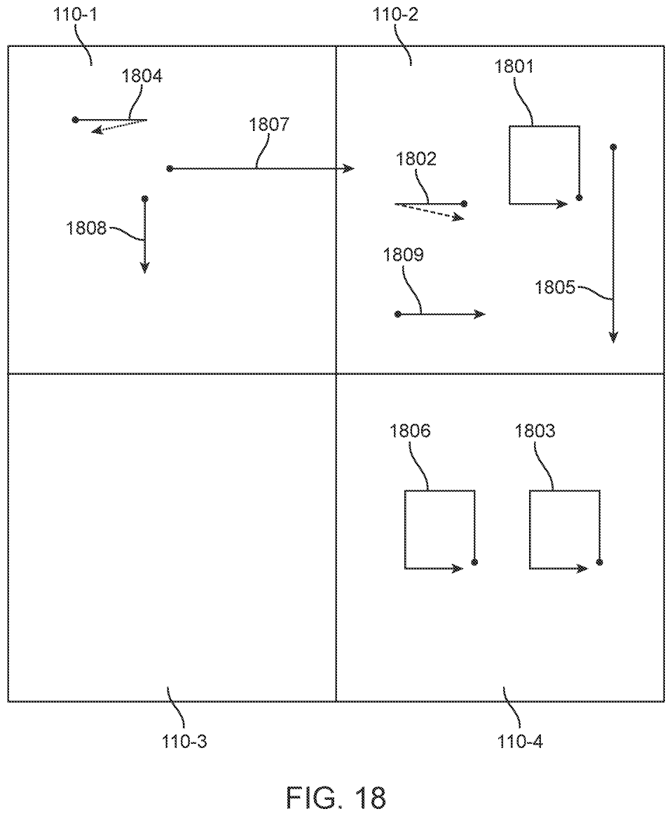

A keyboard interface with input gestures for creating phrases is illustrated in FIG. 18, according to another example of the present subject matter. The number of letters taken from some of the words may be different. In this case, the letters from two words will be separated by a swipe shown by 1803. Consider the phrase “early bird catches the worm”. Let the letters used be: e, b, i, c and w. The swipes 1801 to 1809 in that order, produces the phrase. Here two letters b and i are taken from the word ‘bird’. Only one letter is taken from other words. The swipes 1803 and 1806 provide the delimiters.

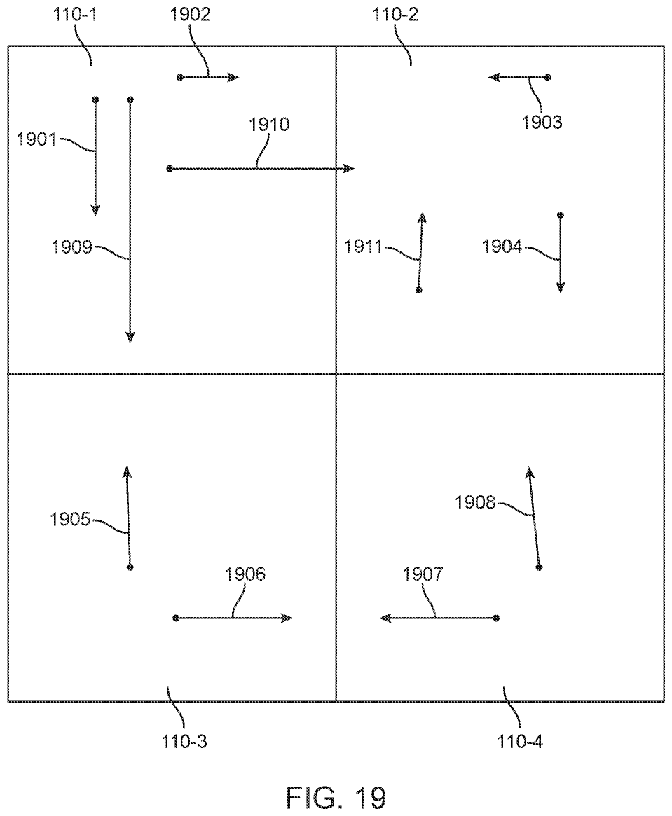

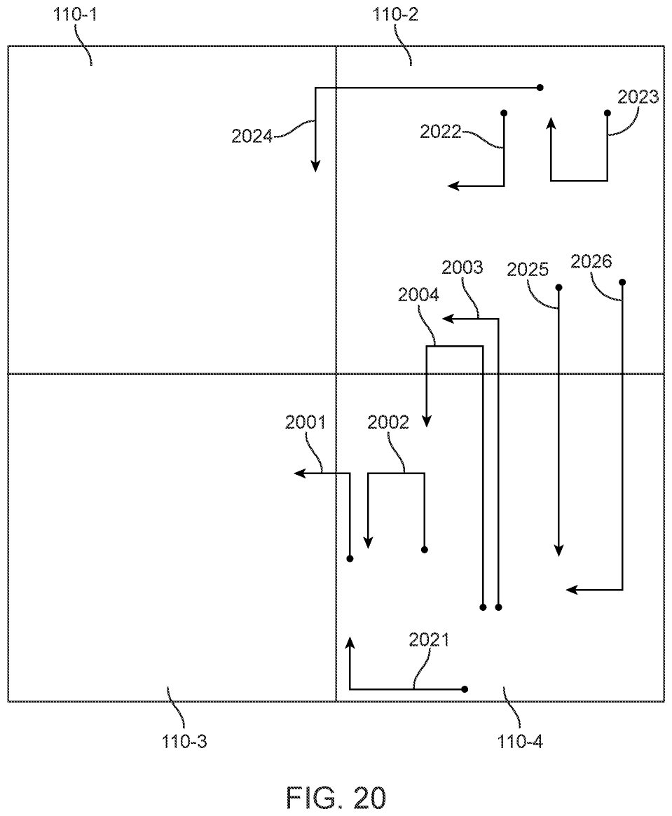

A keyboard interface with input gestures for typing numbers and symbols is illustrated in FIG. 19 and FIG. 20, according to embodiments of the present subject matter. The input trigger 1911 (key 1, up) selects the number and symbol category. The swipes 1901 to 1909 may type the decimal digits 1 to 9. Swipe 1910 may type the digit 0. The swipe operation 2001, 2002, 2003, 2004, may type the mathematical symbols for addition, subtraction, multiplication and division, in that order. The swipes 2021, to 2026, may type the symbols (, @, #, “, decimal point, and comma), in that order.

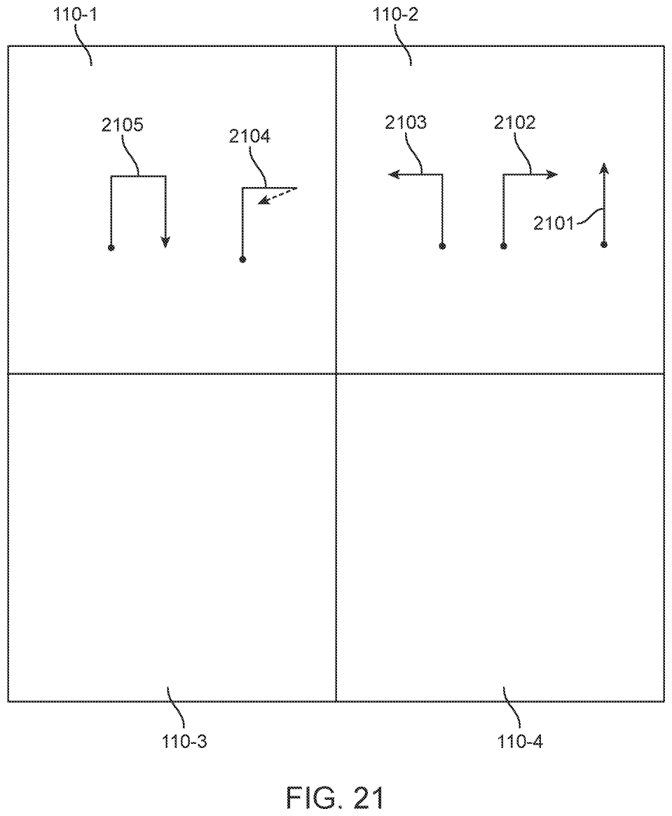

A keyboard interface with input gestures for typing numbers and symbols is illustrated in FIG. 21, according to another embodiment of the present subject matter. When digits and symbols are input one by one through swipes, and then, when 2101 is swiped, the input is completed, and, the output is provided. The power of creating a number in a simple way and changing it to different formats is explained by the following examples. Instead of 2101, if the swipe 2102 is used, the output is changed to that number written in words. For example, when the digits in 1234567 are input, followed by the swipe 2102, the output formed till then changes to “one million two hundred thirty four thousand five hundred and sixty seven”. Here the counting is done using millions and billions. In countries like India, the counting may be done using lakhs and crores. Going through the settings menu, as described earlier, the counting method may be changed. In the lakhs method, the output may be “twelve lakhs thirty four thousand five hundred and sixty seven”.

Swipes for digits 1, 2, and 3, and then the swipe 2105, changes the output “123” as a subscript. Swipes for digits 2, 9, 4, 9, and then the swipe 2104, changes the output “2949” to the Unicode character at code point 2949, which is Tamil letter [symbol] . This device enables the input of any Unicode character in this way. Swipe for digit 1, swipe 2001 for plus, swipe for digit 2, swipe 2103, gives the output after doing the calculations, if any. Here the output changes to “3”. This simple example shows how to use the keyboard to do calculations. Apart from normal calculations, scientific calculations may also be done in the number mode, providing a versatile calculation mode.

In various embodiments, a computer program product having non-volatile memory therein, carrying computer executable instructions stored therein to assist a user for inputting text on an electronic device may be implemented. The instructions include displaying, on a touch-sensitive display of the electronic device, a keyboard interface comprising a set of keys, wherein each key represents a plurality of characters for selection. The instructions may include receiving one or more input gestures on the keyboard interface from a user, wherein the one or more input gestures indicate at least one of input text associated with a preselected language or an input trigger. The instructions include identifying, by a processor of the electronic device, whether the one or more input gestures are indicative of input text or input trigger or both. In response to identifying the one or more input gesture indicative of input text, the instructions include: receiving, by the processor, a combination of predetermined swipe operations and predetermined tap operations to select a word from a preset dictionary database; or receiving, by the processor, a plurality of swipe operations performed continuously to select a word from the preset dictionary database.

In response to identifying the one or more input gestures indicative of input text and input trigger, wherein the input trigger is a gap request, the instructions include: inserting, by the processor, a gap between predetermined letters typed by the user as the input text, and selecting, by the processor, one or more words from the preset dictionary database based on the gap and the predetermined letters. The instructions include predicting a word from the preset dictionary database based on the selected one or more words.

In response to identifying the one or more input gestures indicative of input text and input trigger, wherein the input trigger is a string request: selecting a collection from a plurality of collections stored in a preset string database based on the string request, wherein the plurality of collections comprises letter strings collections and symbol strings collections, identifying a group of words associated with a letter string or a symbol string based on the input text, and predicting a letter string or a symbol string based on the identification. Finally, the instructions include reciting, by a speaker of the electronic device, the predicted words or strings in real-time to the user for selection.

The present subject matter described above provides fast and accurate methods and devices for typing. The keyboard interface and method enables anyone to type fast, and in particular it may enable visually challenged users to type without making errors, and in a convenient manner. Further, the disclosed keyboard embodiments provide several features that would enable efficiency in the typing process performed by visually challenged users.

Although the detailed description contains many specifics, these should not be construed as limiting the scope of the invention but merely as illustrating different examples and aspects of the invention. Various other modifications, changes and variations which will be apparent to those skilled in the art may be made in the arrangement, operation and details of the system and method of the present invention disclosed herein without departing from the spirit and scope of the invention as described here and delineated by the appended claims.

I claim:

1. A method (300) of inputting text on an electronic device, comprising:
displaying (302), on a touch-sensitive display of the electronic device, a keyboard interface comprising a set of keys, wherein each key represents a plurality of characters for selection;
receiving (304), on the touch sensitive display, one or more input gestures on the keyboard interface from a user, wherein the one or more input gestures indicate at least one of input text associated with a preselected language or an input trigger;
identifying (306), by a processor of the electronic device, whether the one or more input gestures are indicative of input text or input trigger or both;
in response to identifying (308) the one or more input gestures indicative of input text:
receiving (312), by the processor, a combination of predetermined swipe operations and predetermined tap operations to select (316) a word from a preset dictionary database; or
receiving (314), by the processor, a plurality of swipe operations (511-547) performed continuously to select (316) a word from the preset dictionary database;
in response to identifying (310) the one or more input gestures indicative of input text and input trigger, wherein the input trigger is a gap request:
inserting (318), by the processor, a gap between predetermined letters typed by the user as the input text,
selecting (316), by the processor, one or more words from the preset dictionary database based on the gap and the predetermined letters, and
predicting (324), by the processor, a word from the preset dictionary database based on the selected one or more words;
in response to identifying (320) the one or more input gestures indicative of input text and input trigger, wherein the input trigger is a string request:
selecting (322) a collection from a plurality of collections stored in a preset string database based on the string request, wherein the plurality of collections comprises a letter strings collection;
identifying a group of words associated with a letter string based on the input text;
predicting (324) the letter string based on the identification; and
reciting (326), by a speaker of the electronic device, the predicted words or letter strings in real-time to the user for selection.

2. The method of claim 1 wherein the one or more input gestures includes a touchless gesture operation interpreted as an operation on a touch screen.

3. The method of claim 1, wherein selecting words based on the combination of predetermined swipe operations and predetermined tap operations further comprises at least one of:
selecting one or more letters of the word using a swipe operation from the preset dictionary database; and
selecting one or more letters of the word using a tap operation from the preset dictionary database.

4. The method of claim 1, wherein the plurality of swipe operations comprises one or more first predetermined sub-swipes and one or more second predetermined sub-swipes.

5. The method of claim 1, wherein the plurality of swipe of operations comprises one or more second predetermined sub-swipes.

6. The method of claim 4, wherein the first predetermined sub-swipes are indicative of navigation from one key to another key and the second predetermined sub-swipes are indicative of a subset of characters associated with a key.

7. The method of claim 1, wherein inserting a gap comprises omitting one or more letters between the predetermined letters typed by the user as the input text.

8. The method of claim 1, wherein the one or more input gestures indicate a text category, the text category comprising a number and symbol category, Braille symbol category, one or more language categories, and formatting category.

9. The method of claim 1, wherein the plurality of collections comprise letter string collection, emoji collection, symbol collection, and wherein the letter string collection comprises phrases collection, idioms collection, proverbs collections, user-defined phrases collection.

10. The method of claim 9, further comprising:
selecting an emoji collection or a symbol collection from the plurality of collections stored in a preset string database based on the string request;
identifying a group of words associated with emojis or symbols based on the input text;
predicting the emojis or symbols based on the identification.

11. The method of claim 1, further comprising: in response to identifying the one or more input gestures indicative of input text and input trigger, wherein the input trigger is a string request and the input text is received using the plurality of swipe operations:
selecting a collection from a plurality of collections stored in a preset string database based on the string request, wherein the plurality of collections comprises a letter strings collection;
identifying a group of words associated with a letter string based on the input text; and
predicting the letter string based on the identification.

12. A portable electronic device (104) to assist a user for inputting text, comprising:
a processor (206);
a touch-sensitive display (202) configured to:
display a keyboard interface (110) comprising a set of keys (110-1, 110-2, 110-3, 110-4), wherein each key represents a plurality of characters for selection;
receive one or more input gestures on the keyboard interface from a user, wherein the one or more input gestures indicate at least one of input text associated with a preselected language or an input trigger;
a memory unit (208) comprising a plurality of modules to be executed by the processor, wherein the plurality of modules comprises:
a gesture module (214) configured to identify whether the one or more input gestures are indicative of input text or input trigger or both;
in response to identifying the one or more input gestures indicative of input text, the processor configured to execute one of:
a hybrid-typing module (216) configured to enable the keyboard interface to receive a combination of predetermined swipe operations and predetermined tap operations to select a word from a preset dictionary database (226); or
a swipe extension module (218) configured to enable the keyboard interface to receive a plurality of swipe operations performed continuously to select a word from the preset dictionary database; wherein,
in response to identifying the one or more input gestures as indicative of input text and input trigger, and wherein the input trigger is a gap request, the processor configured to execute:
a gap method module (220) configured to:
insert a gap between predetermined letters typed by the user as the input text; and
select one or more words from the preset dictionary database based on the gap and the predetermined letters;
in response to identifying the one or more input gestures as indicative of input text and input trigger, wherein the input trigger is a string request, the processor is configured to execute:
a string creation module (222) configured to:
select a collection from a plurality of collections stored in a preset string database (228) based on the string request, wherein the plurality of collections comprises a letter strings collection, and
identify a group of words associated with a letter string based on the input text;
a prediction module (224) configured to:
predict a word from the preset dictionary database based on the one or more words selection by the hybrid-typing module, swipe extension module, or the gap-method module, or
predict the letter string based on the identification by the string creation module; and
a speaker (204) configured to dynamically recite the predicted words or strings in real-time to the user for selection.

13. The device of claim 12, wherein the keyboard interface is configured to receive one or more input gestures comprising a swipe operation, a tap operation, or a touchless gesture operation interpreted as an operation on a touch screen.

14. The device of claim 12, further comprising:
an emoji or symbol creation module configured to:
select an emoji or symbol collection from a plurality of collections stored in a preset string database based on the string request, and
identify a group of words associated with an emoji or symbol based on the input text.

15. A computer program product having non-volatile memory therein, carrying computer executable instructions stored therein to assist a user for inputting text on an electronic device, the instructions comprising:
displaying, on a touch-sensitive display of the electronic device, a keyboard interface comprising a set of keys, wherein each key represents a plurality of characters for selection;
receiving, on the touch sensitive display, one or more input gestures on the keyboard interface from a user, wherein the one or more input gestures indicate at least one of input text associated with a preselected language or an input trigger;
identifying whether the one or more input gestures are indicative of input text or input trigger or both;
in response to identifying the one or more input gestures indicative of input text:
receiving a combination of predetermined swipe operations and predetermined tap operations to select a word from a preset dictionary database; or
receiving a plurality of swipe operations performed continuously to select a word from the preset dictionary database;
in response to identifying the one or more input gestures indicative of input text and input trigger, wherein the input trigger is a gap request:
inserting a gap between predetermined letters typed by the user as the input text,
selecting one or more words from the preset dictionary database based on the gap and the predetermined letters, and
predicting a word from the preset dictionary database based on the selected one or more words;
in response to identifying the one or more input gestures indicative of input text and input trigger, wherein the input trigger is a string request:
selecting a collection from a plurality of collections stored in a preset string database based on the string request, wherein the plurality of collections comprises letter strings collections and symbol strings collections;
identifying a group of words associated with a letter string or a symbol string based on the input text;
predicting a letter string or a symbol string based on the identification; and
reciting, by a speaker of the electronic device, the predicted words or strings in real-time to the user for selection
